(19) United States
(12) Patent Application Publication
(10) Pub. No.: US 2017/0244519 A1
(43) Pub. Date: Aug. 24, 2017

(54) PMI Selection

(71) Applicant: Nokia Solutions and Network Oy, Espoo (FI)

(72) Inventors: Weidong Yang, San Diego, CA (US); Xiaoyi Wang, Hoffman Estates, IL (US); Jian Kang Wang, Beijing (CN)

(21) Appl. No.: 15/503,546

(22) PCT Filed: Aug. 14, 2014
(86) PCT No.: PCT/US2014/050991

§ 371 Date: Feb. 13, 2017

(51) Int. Cl. H04L 1/08; H04L 1/16; H04L 1/00; H04B 7/06; H04L 5/00

(52) U.S. Cl. CPC H04L 1/08; H04B 7/0639; H04B 7/063; H04L 5/0055; H04L 1/0009; H04L 1/0003; H04L 1/1607

(57) ABSTRACT

A method for selecting a precoding matrix indicator that optimizes a retransmission is disclosed. The method comprises causing a transmission initially, with an initial rank, on two codewords, by a base station to at least one user equipment in a wireless network. When the base station receives a negative acknowledgement such that at least one codeword was not decoded successfully, then a decision is made to retransmit using a consequent rank for retransmission, wherein the consequent rank is lower than the initial rank. A precoding matrix indicator for the consequent rank retransmission is selected and a retransmission, with the consequent rank, is made to happen on the at least one codeword that was previously not successfully decoded. Apparatus, program products, and software are also disclosed.

### TECHNICAL FIELD

This invention relates generally to wireless networks and, more specifically, to Precoding Matrix Indicators used in retransmission.

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section.

Channel Quality Indicators (CQIs), and MIMO feedback such as Rank Indicator (RI) or Precoding Matrix Indicator (PMI) are fundamental components of making satisfactory practical use of the available transmission techniques in an LTE downlink.

In LTE, a UE can be configured to report CQIs to assist the eNodeB in selecting an appropriate Modulation and Coding Scheme (MCS) to use for the downlink transmissions. The CQI reports are derived from the downlink received signal quality, typically based on measurements of the downlink reference signals. The reported CQI is not a direct indication of SINR in LTE. Instead, a UE reports the highest MCS that it can decode with a transport block error rate probability not exceeding 10%. Thus the information received by the eNodeB takes into account the characteristics of a UE's receiver, and not just the prevailing radio channel condition.

In LTE, spatial layers are the different streams generated by spatial multiplexing. A layer can be described as mapping symbols to the transmit antenna ports. Each layer is identified by a precoding vector of a size equal to the number of transmit antenna ports and can be associated with a radiation pattern. The number of layers transmitted is the rank of the transmission.

In LTE, a UE can be configured to report RI to indicate the preferable number of spatial layers (transmission rank). A UE can be also configured to report PMI which indicates a certain precoder defined by the LTE specification is preferred by the UE. The LTE precoders are grouped according to the transmission rank (RI); therefore, the reported PMI is conditioned to reported RI. Furthermore, since the PMI will reflect the best beamforming gain, reported CQI is conditioned on reported PMI. Typically, UE will only report its most preferable RI (number of spatial layers), then corresponding PMI and corresponding CQI.

A codeword is an independently encoded data block, which corresponds to a single Transport Block (TB) delivered from the Medium Access Control (MAC) layer in the transmitter to the physical layer and is protected with a Cyclic Redundancy Check (CRC).

Precoding refers to the application of a set of antenna weights per transmitted spatial layer (the precoding matrix) which, when applied to a forthcoming transmission, interact beneficially with the radio channel in terms of improved reception or separation of the layers at the intended receivers.

For ranks greater than 1, two codewords can be transmitted, the number of codewords is always less than or equal to the number of layers, which in turn is always less than or equal to the number of antenna ports.

A spatial multiplexing scheme can use a single codeword mapped to all the available layers, or multiple codewords each mapped to one or more different layers.

Control signaling not associated with uplink data, transmitted independently of any uplink data packet, includes HARQ Acknowledgments (ACK/NACK) for downlink data packets, CQIs, and MIMO feedback such as RI or PMI for downlink transmissions. Scheduling Requests (SRs) for uplink transmissions also fall into this category.

Using precoders generated simplifies the CQI calculation by reducing the number of matrix inversions and the amount of control signaling required.

Using only one codeword reduces the amount of control signaling required, both for CQI reporting, where only a single value would be needed for all layers, and for HARQ ACK/NACK feedback, where only one ACK/NACK would have to be signaled per subframe per UE. Note that multi-user MIMO in LTE supports only rank-1 transmission, one codeword, to each of the selected UEs. Using multiple codewords, a separate codeword can be mapped to each of the layers.

For LTE, at most two codewords are used, even if four layers are transmitted. The codeword-to-layer mapping is static. Also in LTE, all Resource Blocks (RBs) belonging to the same codeword use the same MCS, even if a codeword is mapped to multiple layers.

The PDSCH transmission modes for open-loop spatial multiplexing and closed-loop spatial multiplexing use precoding from a defined ‘codebook’ to form the transmitted layers. Each codebook consists of a set of predefined precoding matrices, with the size of the set being a trade-off between the number of signaling bits required to indicate a particular matrix in the codebook and the suitability of the resulting transmitted beam direction. In the case of closed-loop spatial multiplexing, a UE feeds back to the eNodeB the most desirable entry from a predefined codebook. The preferred precoder is the matrix which would maximize the capacity based on the receiver capabilities. In a single-cell, interference-free environment the UE will typically indicate the precoder that would result in a transmission with an effective SNR following most closely the largest singular values of its estimated channel matrix.

A nested property is a method of arranging the codebooks of different ranks so that the lower rank codebook is comprised of a subset of the higher rank codebook vectors. This property simplifies the CQI calculation across different ranks. It ensures that the precoded transmission for a lower rank is a subset of the precoded transmission for a higher rank, thereby reducing the number of calculations required for the UE to generate the feedback.

In the case of open-loop spatial multiplexing, the feedback from a UE indicates only the rank of the channel, and not a preferred precoding matrix. In this situation, if the rank used for PDSCH transmission is greater than 1 (i.e. more than one layer is transmitted), LTE uses Cyclic Delay Diversity (CDD), which involves transmitting the same set of OFDM symbols on the same set of OFDM subcarriers from multiple transmit antennas, with a different delay on each antenna. The delay is applied before the Cyclic Prefix (CP) is added, thereby guaranteeing that the delay is cyclic over the Fast Fourier Transform (FFT) size. In practice, CDD is only applied in LTE when the rank used for PDSCH transmission is greater than 1. In such a case, each layer benefits independently from CDD in the same way as for a single layer.

For a rank-2 transmission, the transmission on the second antenna port is delayed relative to the first antenna port for each layer, meaning that symbols transmitted on both layers will experience the delay and hence the increased frequency selectivity.

For multilayer CDD operation, the mapping of the layers to antenna ports is carried out using precoding matrices selected from the spatial multiplexing codebooks described earlier. As a UE would not indicate a preferred precoding matrix in the open loop spatial multiplexing transmission mode in which CDD is used, the particular spatial multiplexing matrices selected from the spatial multiplexing codebooks in this case are predetermined.

In the case of 2 transmit antenna ports, the predetermined spatial multiplexing precoding matrix is always the same, namely, the first entry in the 2 transmit antenna port codebook, which is the identity matrix.

In the case of 4 transmit antenna ports, different precoding matrices are used from the 4 transmit antenna port codebook based on the transmission rank. These precoding matrices based on the transmission rank are applied in turn across groups of subcarriers based on the transmission rank in order to provide additional decorrelation between the spatial streams.

A UE can be configured to report CQI, PMIS, and RIs.

CQI values correspond to the preferred rank and precoders, to enable the eNodeB to perform link adaptation and multi-user scheduling. The number of CQI values reported normally corresponds to the number of codewords supported by the preferred rank. Further, the CQI values themselves will depend on the assumed rank: for example, the precoding matrix for layer 1 will usually be different depending on whether or not the UE is assuming the presence of a second layer.

The PMI report is an index of the preferred predetermined spatial multiplexing precoding matrix, the precoder that maximizes the aggregate number of data bits which could be received across all layers.

The channel rank is reported via an RI, which is calculated to maximize the capacity over the entire bandwidth, jointly selecting the preferred precoder per subband to maximize its capacity on the assumption of the selected rank.

### SUMMARY

This section contains examples of possible implementations and is not meant to be limiting.

In one example of an embodiment, a method comprises causing a transmission initially, with an initial rank, on two codewords by a base station to at least one user equipment in a wireless network; receiving a negative acknowledgement such that at least one codeword was not decoded successfully; deciding to retransmit using a consequent rank for retransmission, wherein the consequent rank is lower than the initial rank; selecting a precoding matrix indicator for the consequent rank retransmission; and causing a retransmission, with the consequent rank, on the at least one codeword that was previously not decoded successfully.

A further example of an embodiment is a method comprising the method of the previous paragraph, wherein the initial transmission comprises a precoder for each of the two; codewords.

An additional example of an embodiment is the method of this paragraph and/or the previous paragraphs, wherein number of layers in the consequent rank transmission is less than number of layers in the initial rank transmission.

A further example of an embodiment is a method comprising the method(s) of, this paragraph and/or the previous paragraphs, wherein the deciding is based on at least one of the following: no new data on the codeword to be caused to be retransmitted; or a scheduler decides that the not successfully decoded codeword has a priority to be received.

In yet another example of an embodiment, a method comprises any of the methods of this paragraph and/or the previous paragraphs, wherein selecting the precoding matrix indicator for the consequent rank retransmission comprises: determining a precoding matrix indicator from the initial rank transmission; and identifying a precoder used by the codeword with better performance in the initial rank transmission.

Another example of an embodiment comprises a method of any one of the methods in this and/or a previous paragraphs, wherein the performance of each codeword is defined according to the modulation and coding scheme used in the initial transmission and positive acknowledgement or negative acknowledgement of each codeword.

Another example of an embodiment is a method of any one of this and/or the preceding paragraphs, wherein the identifying comprises: choosing the codeword with a higher modulation and coding scheme if different modulation and coding schemes are used; or choosing the codeword with the positive acknowledgement if same modulation and coding scheme is used.

Yet a further example of an embodiment comprises a method of this and/or the previous paragraphs, wherein determining a precoding matrix indicator from the initial rank transmission comprises ascertaining the user equipment reported rank and precoding matrix indicator.

In another example of an embodiment, an apparatus comprises means for causing a transmission initially, with an initial rank, on two codewords by a base station to at least one user equipment in a wireless network; receiving a negative acknowledgement such that at least one codeword was not decoded successfully; deciding to retransmit using a consequent rank for retransmission, wherein the consequent rank is lower than the initial rank; selecting a precoding matrix indicator for the consequent rank retransmission; and causing a retransmission, with the consequent rank, on the at least one codeword that was previously not decoded successfully.

A further example of an embodiment is an apparatus comprising the apparatus of the previous paragraph, wherein the initial transmission comprises a precoder for each of the two codewords.

An additional example of an embodiment is the apparatus of this paragraph and/or the previous paragraphs, wherein number of layers in the consequent rank transmission is less than number of layers in the initial rank transmission.

A further example of an embodiment is an apparatus comprising the apparatus of this paragraph and/or the previous paragraphs, wherein the deciding is based on at least one of the following: no new data on the codeword to be caused to be retransmitted; or a scheduler decides that the not successfully decoded codeword has a priority to be received.

In yet another example of an embodiment, an apparatus comprises any of the apparatus of this paragraph and/or the previous paragraphs, and further comprises wherein selecting the precoding matrix indicator for the consequent rank retransmission comprises: determining a precoding matrix indicator from the initial rank transmission; and identifying a precoder used by the codeword with better performance in the initial rank transmission.

Another example of an embodiment comprises an apparatus of any one of the apparatus in this and/or a previous paragraphs, wherein the performance of each codeword is defined according to the modulation and coding scheme used in the initial transmission and positive acknowledgement or negative acknowledgement of each codeword.

Another example of an embodiment is an apparatus of any one of this paragraph and/or the preceding paragraphs, wherein the identifying comprises: choosing the codeword with a higher modulation and coding scheme if different modulation and coding schemes are used; or choosing the codeword with the positive acknowledgement if same modulation and coding scheme is used.

Yet a further example of an embodiment comprises an apparatus of this paragraph and/or the previous paragraphs, wherein determining a precoding matrix indicator from the initial rank transmission comprises ascertaining the user equipment reported rank and precoding matrix indicator.

In a further example of an embodiment, an apparatus comprises one or more processors and one or more memories including computer program code. The one or more memories and the computer program code configured, with the one or more processors, to cause the apparatus to perform at least the following: causing a transmission initially, with an initial rank, on two codewords by a base station to at least one user equipment in a wireless network; receiving a negative acknowledgement such that at least one codeword was not decoded successfully; deciding to retransmit using a consequent rank for retransmission, wherein the consequent rank is lower than the initial rank; selecting a precoding matrix indicator for the consequent rank retransmission; and causing a retransmission, with the consequent rank, on the at least one codeword that was previously not decoded successfully.

Another example of an embodiment comprises a computer program comprising code for sending a message causing a transmission initially, with an initial rank, on two codewords by a base station to at least one user equipment in a wireless network; receiving a negative acknowledgement such that at least one codeword was not decoded successfully; deciding to retransmit using a consequent rank for retransmission, wherein the consequent rank is lower than the initial rank; selecting a precoding matrix indicator for the consequent rank retransmission; and causing a retransmission, with the consequent rank, on the at least one codeword that was previously not decoded successfully, when the program is run on a data processing apparatus. The computer program of this paragraph, wherein the computer program is a computer program product comprising a computer-readable medium bearing computer program code embodied therein for use with a computer.

### BRIEF DESCRIPTION OF THE DRAWINGS

In the attached Drawings:

FIG. 1 illustrates a simplified block diagram of a system in which some examples of embodiments of this invention may be practiced;

FIG. 2 displays a table of codebook for transmission on antenna ports;

FIG. 3 displays a table used to determine which codeword's precoder performed better in the first transmission according to some examples of embodiments of the invention;

FIG. 4A displays a table defining Rank 4 Precoders according to some examples of embodiments of the invention;

FIG. 4B displays a table to select the retransmission PMI (rank 2) according to, best codeword in initial transmission according to some examples of embodiments of the invention;

FIG. 4C displays a table to define rank 2 precoders according to best codeword in initial transmission according to some examples of embodiments of the invention;

FIG. 5 displays a table of reference vectors defined to analyze rank 4 and rank 2 codewords according to some examples of embodiments of the invention;

FIG. 6 illustrates a flowchart of a method according to some examples of embodiments of the invention; and

FIG. 7 illustrates a flowchart of a method according to some examples of embodiments of the invention.

### DETAILED DESCRIPTION OF THE DRAWINGS

As stated in the Background section, above, typically a UE will only report its most preferable RI (number of spatial layers), then corresponding PMI and corresponding CQI. However, when an initial transmission gets an ACK and a NACK, the retransmission may have lower rank. Therefore, the eNB does not know the corresponding PMI since the reported PMI is conditioned to a higher rank. What we propose is a new rank 2 retransmission PMI selection scheme, where the PMI selection is based on the first transmission results.

The examples of embodiments herein describe techniques for PMI selection for retransmission with different rank than initial transmission. Additional description of these techniques is presented after a system into which the examples of embodiments may be used is described.

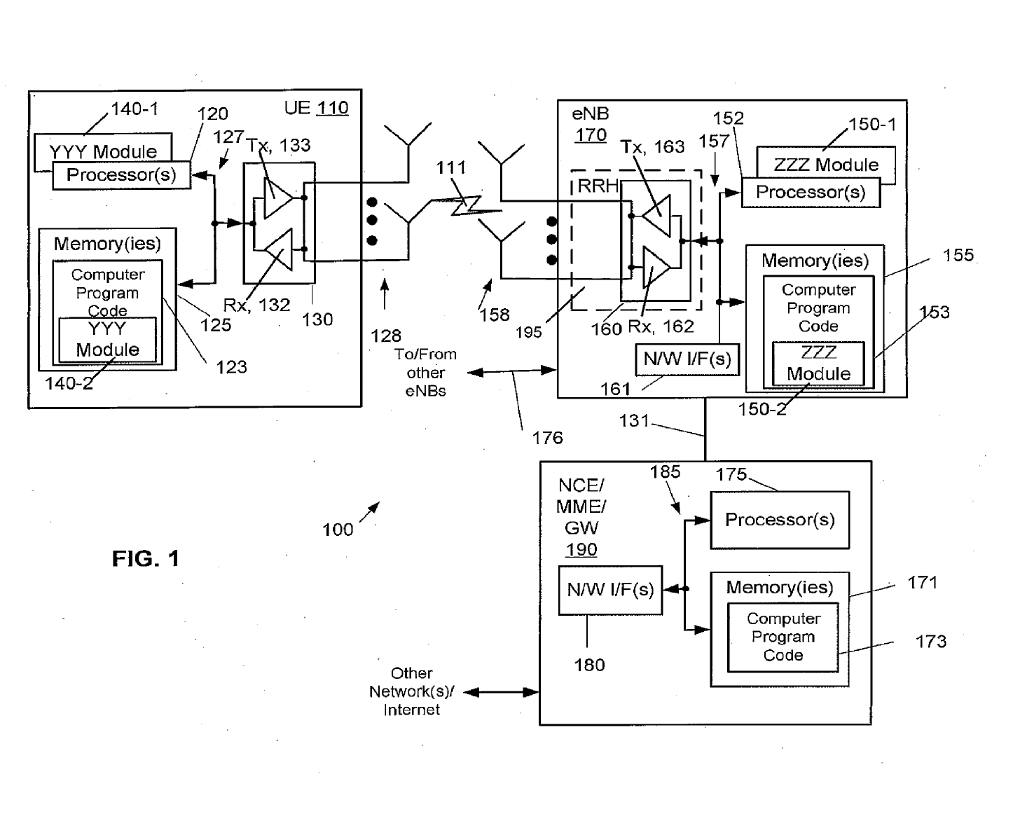

FIG. 1 shows a block diagram of an system in which the examples of embodiments of the invention may be practiced. The eNB 170 is a base station that provides access by wireless devices such as the UE 110 to the wireless network 100. The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The eNB 170 includes a ZZZ module 150, comprising one of or both parts 150-1 and/or 150-2, which may be implemented in a number of ways.

The ZZZ module 150 may be implemented in hardware as ZZZ module 150-1, such as being implemented as part of the one or more processors 152. The ZZZ module 150-1 may be implemented also as an integrated circuit or through other hardware such as a programmable gate array. In another example, the ZZZ module 150 may be implemented as ZZZ module 150-2, which is implemented as computer program code 153 and is executed by the one or more processors 152. For instance, the one or more memories 155 and the computer program code 153 are configured to, with the one or more processors 152, cause the eNB 170, to perform one or more of the operations as described herein. The one or more network interfaces 161 communicate over a network such as via the links 176 and 131. Two or more eNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

Turning to other devices in FIG. 1, a UE 110 is in wireless communication with a wireless network 100. The user equipment 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123.

The UE 110 includes a YYY module 140, comprising one of or both parts 140-1 and/or 140-2, which may be implemented in a number of ways. The YYY module 140 may be implemented in hardware as YYY module 140-1, such as being implemented as part of the one or more processors 120. The YYY module 140-1 may be implemented also as an integrated circuit or through other hardware such as a programmable gate array. In another example, the YYY module 140 may be implemented as YYY module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with eNB 170 via a wireless link 111.

The wireless network 100 may include a network control element (NCE) 190 that may include MME/SGW functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented using hardware such as processors 152 or 175 and memories 155 and 171.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments of the user equipment 110 can include, but are not limited to, cellular telephones such as smart phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions.

Embodiments herein may be implemented in software (executed by one or more processors), hardware (e.g., an application specific integrated circuit), or a combination of software and hardware. In an example of an embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memories 125, 155, 171 or other device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects are set out above, other aspects comprise other combinations of features from the described embodiments, and not solely the combinations described above.

It is also noted herein that while the above describes examples of embodiments of the invention, these descriptions should not be viewed in a limiting sense. Rather, there are several variations and modifications which may be made without departing from the scope of the present invention.

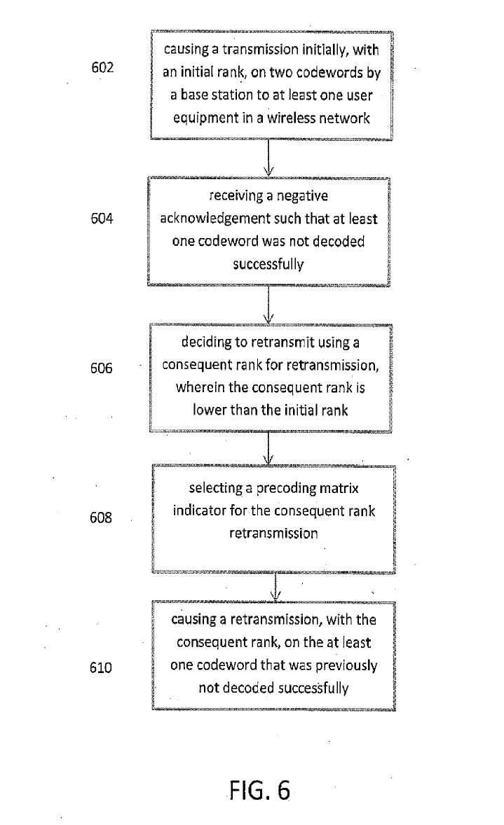

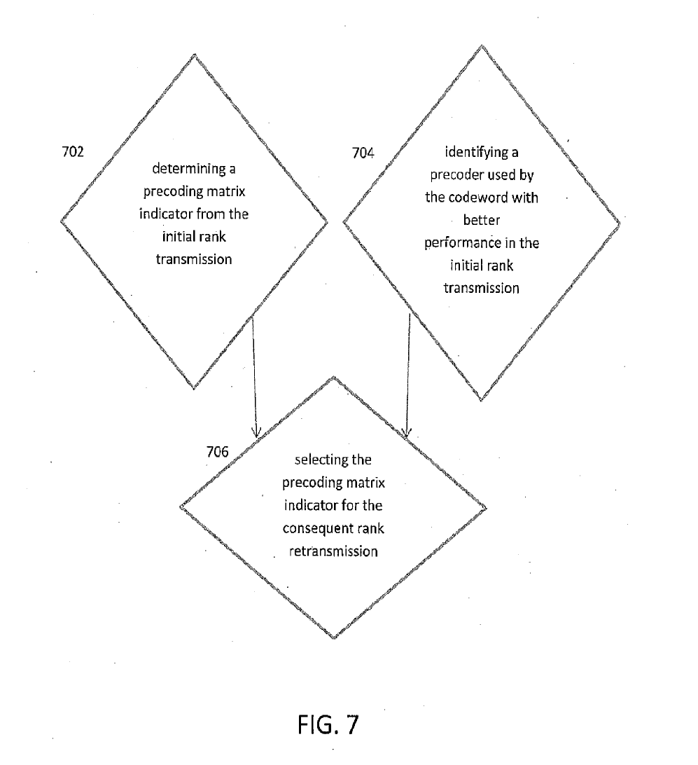

The apparatus such as a eNB 170 can provide functionality to the operations described herein below. FIG. 6 is a block diagram of an example of a logic flow diagram that illustrates the operation of an example of a method, a result of execution of computer program instructions embodied on a computer readable memory, and/or functions performed by logic implemented in hardware, in accordance with exemplary embodiments herein. The blocks in the figure may be considered to be means for performing the function in the blocks. Furthermore, each block in FIG. 6 may be implemented as a module, such as a circuit or other hardware, for performing the function in the block. For instance, block 606 may be a module such as circuitry that performs deciding to retransmit using a consequent rank for retransmission. As another example, block 608 may be a module that depicts selecting a precoding matrix indicator for the consequent rank retransmission. Consequent is an adjective that means happening as a result of a particular action or set of conditions. As discussed elsewhere herein, the consequent rank is lower than the initial rank. The blocks in FIG. 6 may be an example of an implementation of the ZZZ module in FIG. 1, such that the ZZZ module would be the PMI Selection module. Thus, in FIG. 1, eNB 170, e.g., under control of the ZZZ module, performs the blocks in FIG. 6 and FIG. 7. The eNB 170 or ZZZ module of FIG. 1 could also be thought of as the means for performing the steps of the method or any aspects of the methods described herein or as illustrated in FIG. 6 or FIG. 7. Moreover, the YYY module may also be means of performing any method described herein.

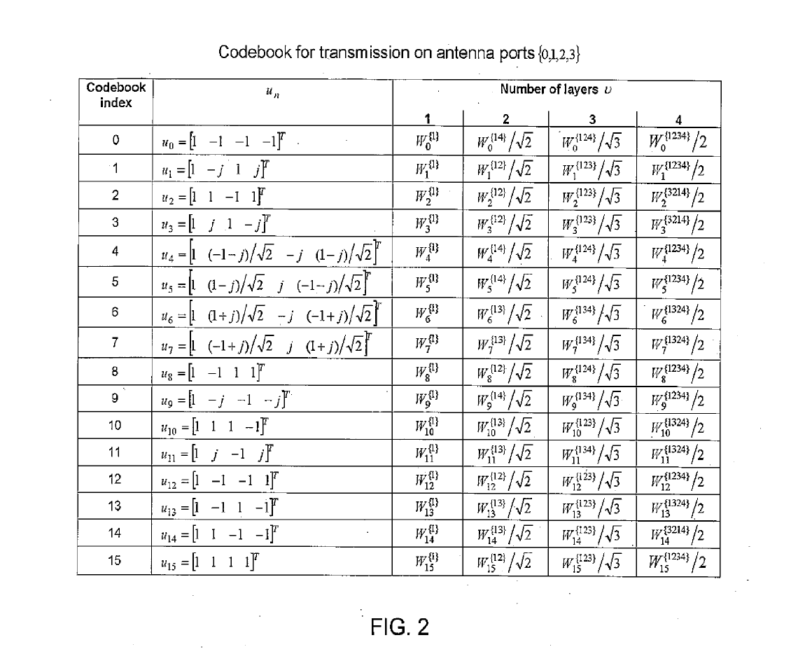

FIG. 2 shows table 6.3.4.2.3-2, in 3GPP TS 36.211, given for rank 1/2/3/4 for the Rel-8 codebook, and entitled “Codebook for transmission on antenna ports {0,1,2,3} and for CSI reporting based on antenna ports {0,1,2,3} or {15,16,17,18}”. As discussed in 3GPP TS 36.211, the quantity Wₙ^{{s}} denotes the matrix defined by the columns given by the set {s} from the expression Wₙ=I−2uₙuₙ^{H}/u_{b}^{H}uₙ where I is the 4×4 identity matrix and the vector uₙ is given by Table 6.3.4.2.3-2. Regarding the LTE codebook, for all transmissions, the precoder can only be selected from this table. The current invention concerns how to select a PMI for retransmission with different rank than the initial transmission.

For example, in the LTE specification for 4Tx transmission, if the first transmission is rank 4 or 3 (expressed as “4/3”), then two codewords (2 transport blocks) are transmitted. If one codeword is decoded successfully and another is not, then eNB has to choose rank 2 for retransmission when there is no new data coming or the scheduler decides the incorrectly decoded transport block has a priority to be received (e.g. to meet a delay bound). The result is that a downgraded rank 2 PMI is needed in the retransmission, such that the eNB would need to choose a downgraded rank 2 PMI for retransmission.

Another scenario is that if the first transmission is rank 4/3/2, then two codewords were transmitted and both codewords wrong, and from the UE the eNB receives a report of a new PMI which is at a lower rank 3/2/1, we can use the new PMI with first used PMI to derive the optimal PMI for retransmission.

A typical way of determining the downgraded precoder is to choose a precoder at a lower rank with the same codebook index as that in the rank 4 transmission. Thus is a simple approach, because the LTE nested codebook guarantees that the precoder of the two layers for the retransmission is a submatrix of the precoder for rank 4 transmission. However, this method may not be the optimal solution for the following reasons. For instance, using the first precoder as an example a UE feeds back the rank 4 PMI at index 0. The CQI1 (for layers 1-2) is higher than CQI2 (for layer 3-4). For the first transmission, NACK is received for the codeword on layers 1-2, and ACK is received for the codeword on layers 3-4. Using the rank 2 codeword on the same row (row 0 as shown in FIG. 2) would lead the eNB to use columns 1 and 4 of W₀^{{1234}} for retransmission. But column 4 of W₀^{{1234}} is an inferior choice compared to column 2 of W₀^{{1234}.}

At the time of this invention, there is no algorithm on PMI selection for rank 2 retransmission for an initial transmission at rank 4. Herein is described a method for selecting PMI used in retransmission in the case where the latest Rank is different from the used Rank in initial transmission (e.g. Rank 4→Rank 2). Such a method may provide more optimal HARQ performance and improved cell throughput than without performing such a method.

We propose a new rank 2 retransmission PMI selection scheme, where the PMI selection is based on the first transmission results.

For an initial transmission with Rank 4, where an ACK and a NACK is received by an eNB, the eNB has several choices. One choice is to do retransmission for rank 2. Another choice is to do a rank 4 retransmission with some new data on the finished codeword if there is new data coming. In order to achieve better performance for a retransmission, the eNB can choose to do a rank 2 retransmission.

Thus, when for a rank 4 first transmission, the eNB received one ACK and one NACK (on each codeword separately), and eNB chooses to do retransmission with rank 2 codebook (one codeword), the eNB shall first determine which codeword's precoder in the first transmission will perform better in the retransmission: the precoder of the first codeword or precoder of the second codeword. Then it shall follow the better precoder from the first transmission.

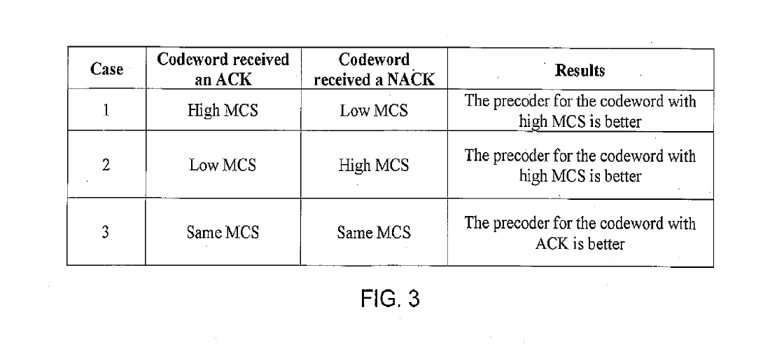

The better precoder in the first transmission is determined by the MCS and HARQ feedback (ACK/NACK) for each codeword. The table in FIG. 3 is used to determine which codeword's precoder is better in the first transmission.

We propose the following principle to choose the rank 2 retransmission PMI and generate the table shown in FIG. 3.

The goal of selecting rank 2 retransmission PMI is to select which precoder has the better performance in the first transmission. Two pieces of information available at eNB when deciding the retransmission PMI are, namely, first, the MCS of each codeword, and, second, the ACK/NACK results on each codeword.

Since the MCS selection is based on the UE reported CQIs, if one codeword has a better CQI than another (wherein better can mean, in its more colloquial sense, more optimal or efficient, or in other words, a higher level of performance as known in the inductry), it means the UE expects a better effective SINR on the layers mapping to that codeword. Normally, it means a larger Eigen-value of the effective channel seen by UE. The layers of the higher MCS codeword should perform better than others.

When the same MCS is reported, it typically means that a similar effective SINR is observed by the LIE on two codewords. In that case, the codeword receiving an ACK from the first transmission (that codeword is successfully decoded) would mean the corresponding layers have better performance than the other one.

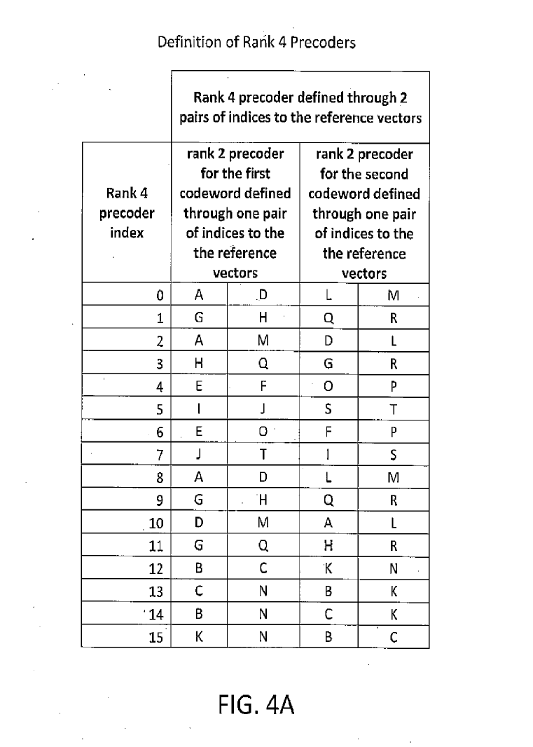

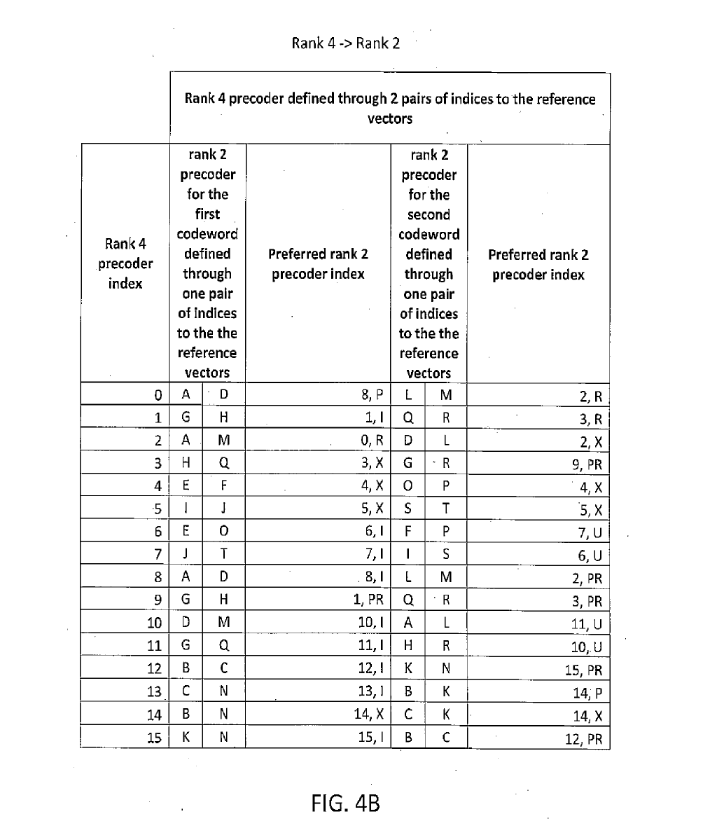

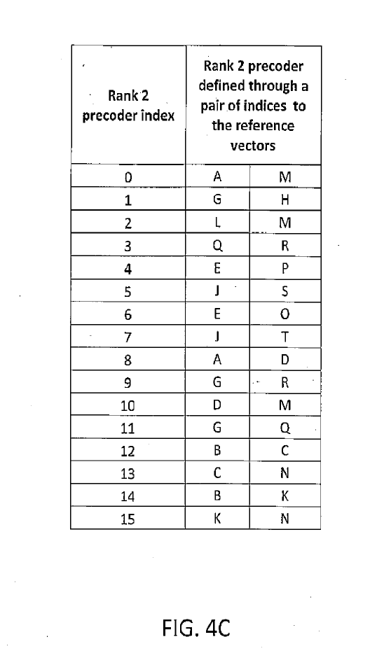

Once one has determined which codeword's precoder performs better in the first transmission, the table in FIG. 4B can be used to select the optimal rank 2 PMI index for retransmission (Re-Tx the codeword received with NACK).

How the table is used is described herein. Select PMI for lower rank retransmission based on (1) the selected PMI from first high rank transmission and (2) the performance of each codeword in initial transmission. The performance of each codeword is defined according to the MCS used in the initial transmission and the ACK/NAK of each codeword. If a different MCS used, then the codeword with higher MCS is defined as the one, with better performance. If the same MCS used, then the codeword with ACK is defined as the one with better performance. Thus, the table is constructed such that the PMI of low rank retransmission shall include the precoder used by the codeword with better performance in the first high rank transmission.

FIG. 4B shows a table, which is generated as shown below, which involves how to select the PMI when eNB knows which precoder is better in retransmission. Once the better codeword in the first transmission is determined, it is better for eNB to select the same precoder of that codeword for retransmission. However, the rank 2 codebook may include the precoder of one or two layers on a particular codeword from the first transmission. Based on our analysis, we find the most suitable rank 2 PMI corresponding to the best codeword in the first transmission.

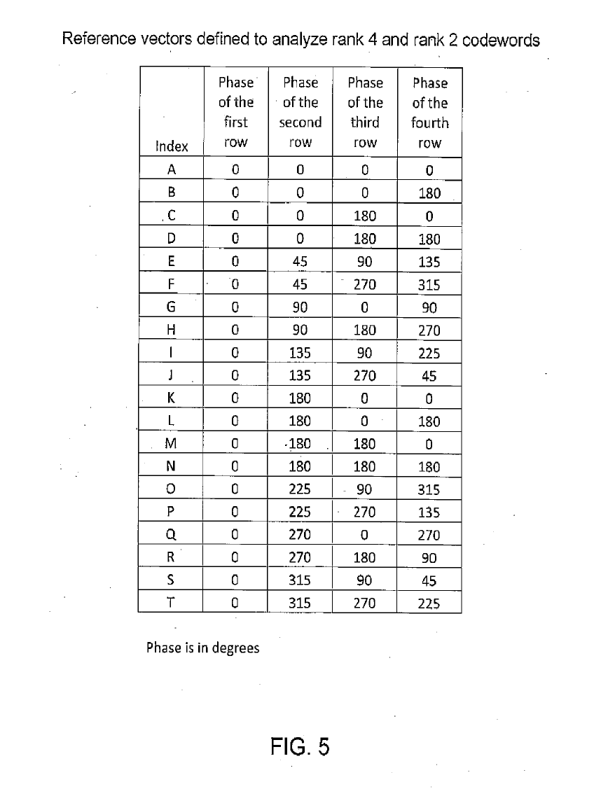

The Rel-8 codebook is currently the most commonly used codebook, and we analyze it herein below. In the table shown in FIG. 5, we first give a unique index to each column vector in the 16 rank 4 precoders. And the codewords in rank 2 and rank 4 as given in FIG. 2 are represented by the column vector indices. For example, W₀^{{1234}}/2 which is the rank 4 precoder at index 0 in FIG. 2 is represented by [A, D, L, M] in FIG. 4A and FIG. 4B, and W₀^{{14}}/\sqrt{2} which is the rank 2 precoder at index 0 in FIG. 2, is represented by [A, M] in FIG. 4C.

The details are provided are provided in the following discussion.

We turn to the table in FIG. 4A. To help build understanding of the issue at hand, as an example, we consider codewords 0 and 2. Codeword 0 (P₀) is given by

$$[ \begin{matrix}1 & 1 & 1 & 1 \\ 1 & 1 & - 1 & - 1 \\ 1 & - 1 & 1 & - 1 \\ 1 & - 1 & - 1 & 1\end{matrix} ]$$

and codeword 2 (P₂) is given by

$$[ \begin{matrix}1 & - 1 & 1 & - 1 \\ 1 & 1 & - 1 & - 1 \\ 1 & 1 & 1 & 1 \\ 1 & - 1 & - 1 & 1\end{matrix} ]$$

so we have

$${P}_{2} = {P}_{0} [ \begin{matrix}1 & 0 & 0 & 0 \\ 0 & 0 & 0 & - 1 \\ 0 & 0 & 1 & 0 \\ 0 & - 1 & 0 & 0\end{matrix} ]$$

as a result. We can see P₂ is obtained from P₀ through a column permutation [1 4 3 2], and phase rotation. We also have

$${P}_{8} = {P}_{0} [ \begin{matrix}0 & 1 & 0 & 0 \\ 1 & 0 & 0 & 0 \\ 0 & 0 & 0 & - 1 \\ 0 & 0 & - 1 & 0\end{matrix} ]$$

$${P}_{10} = {P}_{0} [ \begin{matrix}0 & 0 & 0 & 1 \\ 0 & - 1 & 0 & 0 \\ 0 & 0 & - 1 & 0 \\ 1 & 0 & 0 & 0\end{matrix} ]$$

$${P}_{3} = {P}_{1} [ \begin{matrix}- 1 & 0 & 0 & 0 \\ 0 & 0 & 0 & 1 \\ 0 & 0 & - 1 & 0 \\ 0 & 1 & 0 & 0\end{matrix} ]$$

$${P}_{9} = {P}_{1} [ \begin{matrix}0 & - j & 0 & 0 \\ j & 0 & 0 & 0 \\ 0 & 0 & 0 & j \\ 0 & 0 & - j & 0\end{matrix} ]$$

$${P}_{11} = {P}_{1} [ \begin{matrix}0 & 0 & 0 & j \\ 0 & j & 0 & 0 \\ 0 & 0 & - j & 0 \\ - j & 0 & 0 & 0\end{matrix} ]$$

$${P}_{13} = {P}_{12} [ \begin{matrix}0 & 0 & 1 & 0 \\ 1 & 0 & 0 & 0 \\ 0 & 0 & 0 & 1 \\ 0 & 1 & 0 & 0\end{matrix} ]$$

$${P}_{14} = {P}_{12} [ \begin{matrix}1 & 0 & 0 & 0 \\ 0 & 0 & 0 & 1 \\ 0 & 0 & 1 & 0 \\ 0 & 1 & 0 & 0\end{matrix} ]$$

$${P}_{15} = {P}_{12} [ \begin{matrix}0 & 0 & 0 & - 1 \\ 0 & 0 & - 1 & 0 \\ 0 & - 1 & 0 & 0 \\ - 1 & 0 & 0 & 0\end{matrix} ]$$

$${P}_{6} = {P}_{4} [ \begin{matrix}0 & - j & 0 & 0 \\ 0 & 0 & 0 & j \\ j & 0 & 0 & 0 \\ 0 & 0 & - j & 0\end{matrix} ]$$

$${P}_{7} = {P}_{5} [ \begin{matrix}0 & j & 0 & 0 \\ 0 & 0 & 0 & - j \\ - j & 0 & 0 & 0 \\ 0 & 0 & j & 0\end{matrix} ]$$

To explain the steps we take to arrive at the table in FIG. 4B, we first answer the question whether a unitary transform affects the SINRs at the UE by examining the SINR when a unitary matrix such as u is applied as part of the precoder at the transmit side. Let the receiver model be

r=hwx+n,

where h is the M×N channel matrix, and w is a N×v precoder applied at eNB, and N is the number of transmit antennas at eNB, and v is the transmit rank or layers of x, x is a v×1 vector, n is a M×1 vector for the intererence and noise seen at M receive antennas at a UE. We denote hw by H. Let the covariance matrix due to n be G. Then we have the SINR at stream or spatial layer p (we use “stream” and “spatial layer” interchangeably), 1≦p≦v is given by

SINRₚ=1gₚ−1

where gₚ is the p-th diagonal element of

$$\underbrace{{( {H}^{″} {G}^{- 1} H + {I}_{m} )}^{- 1}}_{B} .$$

If a unitary matrix u is applied to w (i.e. the precoder is wu), the receiver model is

r=hwux+n,

then we can see in this case the SINR at stream or spatial layer p, 1≦p≦v is given by

SINR=1/\tilde{g}ₚ−1

where \tilde{g}ₚ is the p-th diagonal element of

u^{H}(H^{H}G⁻¹H+Iₘ)⁻¹u=u^{H}Bu.

The diagonal elements of u^{H}Bu change according to the applied u. If the construction of the unitary matrix u is limited to permutation and/or phase rotation, then the SINRs for two spatial streams or layers are just re-ordered or permutated. Then there is no difference in terms of throughput if the precoder is w or wu. From this we understand if we obtain a new precoder wu from re-ordering the columns of w the precoder of a codeword, and/or applying phase rotations to the columns of these columns, the new precoder wu leads to the same performance as w. Hence in terms of througput/SINR performance, w and wu are equivalent.

In the 4Tx LTE codebook from Rel-8, which is provided in FIG. 2, there are 4 columns in a rank 4 precoder, and 3 columns in a rank 2 precoder, and 2 columns in a rank 2 precoder, and 1 column in a rank 1 precoder. Because of the so-called nested property of the Rel-8 codebook, a rank r precoder with r<4 in the LTE Rel-8 codebook is a 4×r matrix, which is a submatrix of some rank 4 precoder in the LTE Rel-8 codebook. More exactly, in the LTE Rel-8 codebook, any rank r precoder's columns can be found in the columns of a rank 4 precoder. From this observation, we first build a reference vector table by examining all the column vectors of all the rank 4 precoders, and the reference vector table can be used to describe all precoders in the LTE Rel-8 codebook. As there are 16 rank 4 precoders, we obtain 16×4=64 vectors. Next we normalize those 64 vectors: each vector is divided by its first element, so the resulted vector has “1” as the first element: mathematically if vⱼ=[v_{j,1} v_{j,2} v_{j,3} v_{j,4}]^{T}, where T is the transpose operator, is a column vector, then \tilde{v}ⱼ=vⱼ/v_{j,1} is the normalized vector. This normalization step is justified by the equivalence of w and wu as shown before, as in the normalization step a phase rotation is used. It turns out there are only 20 unique vectors among thus resulted 64 vectors, and they are provided in FIG. 5. As we will use them to characterize rank 2 precoders and rank 4 precoders subsequently, we call them “reference vectors”. For example reference vector A is [1 1 1 1]^{T}, and reference vector D is [1 1 −1 −1]^{T}, where T is the transpose operator as noted before.

Now having defined the reference vectors, we can also define rank 2 precoders in FIG. 2 with those reference vectors, the resulted definition is provided in FIG. 4C. Each rank 2 precoder has two column vectors, say [v₁ v₂], we first normalize v₁ and v₂ to obtain \tilde{v}₁ and \tilde{v}₂. We then look up \tilde{v}₁ and \tilde{v}₂ from the reference vector table. For example, by following the definition provided in section 6.3.4.2.3 Codebook for precoding, 3GPP TS 36.211, rank 2 precoder with index 0 in FIG. 2 is

$$[ \begin{matrix}{v}_{1} & {v}_{2}\end{matrix} ] = {\frac{1}{2 \sqrt{2}} [ \begin{matrix}1 & 1 & 1 & 1 \\ 1 & - 1 & - 1 & 1\end{matrix} ]}^{T} ,$$

and \tilde{v}₁ is the same as reference vector A, and \tilde{v}₂ is the same as reference vector M. Hence A and M are entered for the rank 2 precoder with index 0 in table in FIG. 4C. Now examine rank 2 precoder with index 3 in FIG. 2, by following the definition provided in section 6.3.4.2.3 Codebook for precoding, 3GPP TS 36.211 it is found that

$$[ \begin{matrix}{v}_{1} & {v}_{2}\end{matrix} ] = {\frac{1}{2 \sqrt{2}} [ \begin{matrix}1 & - j & - 1 & j \\ j & 1 & j & 1\end{matrix} ]}^{T} ,$$

and \tilde{v}₁ is the same as reference vector R, and \tilde{v}₂ is the same as reference vector Q. Note in table in FIG. 4C, for rank 2 precoder with index 3, Q and R are entered instead of R and Q. In general, we sort the two letter indices in the alphabetical order. This treatment is also justified by the equivalence of w and wu as shown above when u is a permutation matrix. This is intentionally done so the search for the optimal downgraded rank 2 precoder from a rank 4 precoder is facilitated. From this procedure, a pair of indices to the reference vectors is identified for all rank 2 precoders defined in the LTE Rel-8 codebook.

For a rank 4 precoder say [v₁ v₂ v₃ v₄], where v₁ and v₂ are used for the first codeword; and v₃ and v₄ are used for the second codeword. We first identify a pair of indices to reference vectors corresponding to v₁ and v₂, following the same procedure as for the rank 2 precoders given above. For example for rank 4 precoder with index 0 in FIG. 2, [v₁ v₂ v₃ v₄] is first found from the definition provided in section 6.3.4.2.3 Codebook for precoding, 3GPP TS 36.211. Then for v₁ and v₂, A and D, the pair of indices to reference vectors, are identified. Then we identify a pair of indices to reference vectors corresponding to v₃ and v₄, again following the same procedure as for the rank 2 precoders given above. For example, for rank 4 precoder with index 0, from v₃ and v₄, L and M, the pair of indices to reference vectors are identified and are provided in tables in FIG. 4A and FIG. 4B. Note each pair is sorted in the alphabetical order as in the case for rank 2 precoders. The table in FIG. 4B has all the information from table in FIG. 4A, with one additional column for each codeword with labels such as “8,P”, “1,I”, . . . or “2,R”, “3,R” . . . , which are for the preferred rank 2 precoder's index in FIG. 4C, and the characterization of the matrix u. The details are provided below.

Now we can identify the optimal downgraded rank 2 precoder by matching a pair of indices in table in FIG. 4B to pairs of indices in the table in FIG. 4C. If there is an exact match, then the index of the rank 2 precoder in table in FIG. 4C is entered in the tables in FIG. 4B. In case there is no exact match for the pair \tilde{v}₁ and \tilde{v}₂ in the table in FIG. 4C, then we form a matrix AA^{H}, A=[\tilde{v}₁ \tilde{v}₂], and for the pair of normalized vectors corresponding to a rank 2 precoder in table in FIG. 4C, say w₁ and w₂, we form B=[\tilde{w}₁ \tilde{w}₂], and test whether we can find a permtuation matrix (possibly with phase rotation(s) also) u so A=Bu or not. If there is such a u, then the index of the rank 2 precoder from table in FIG. 4C is entered in the table in FIG. 4B.

We use labels such as “I”, “R”, “P”, “PR”, “U” for the operation needed to relate the rank 2 precoder in FIG. 4C and [v₁ v₂] or [v₃ v₄] from table in FIG. 4A or FIG. 4B: where “I” standards for exact match (i.e. with the Identity matrix or in another word without permtuation or phase rotation), “R” stands for match with phase rotation; “P” stands for match with permtuation, “PR” stands for match with permutation and phase rotation, “U” stands for match with a unitary matrix. The index before such a label is for the preferred rank 2 precoder in FIG. 4C. For example, for rank 4 precoder index 0, “8,P” is the entry for the first codeword, and rank 2 precoder with index 8 in FIG. 4C then is the preferred precoder for retransmission; and “2,R” is the entry for the second codeword and rank 2 precoder with index 2 in FIG. 4C then is the preferred precoder for retransmission.

After the above procedure, we find there are still some entries not covered, and they are marked with “X”. In this case, the index of the rank 4 precoder is used for the rank 2 precoder for retransmission. For example, for rank 4 precoder with index 3 in FIG. 4B, “3,X” is the entry for the first codeword for the column “preferred rank 2 precoder index”.

An alternative test can developed to test whether there is a unitary u for A and B, so A=Bu. When such a u exists, then u=A^{H} A)⁻¹A^{H} B, where His the Hermitian operator, so the 16 rank 2 precoders in LTE Rel-8 codebook can be tested to see whether (A^{H} A)⁻¹A^{H}B is unitary or not, where A is from the rank 2 precoder in table in FIGS. 4C and B is [v₁ v₂] or [v₃ v₄] for the rank 4 precoder in FIG. 4A and FIG. 4B.

With the knowledge of which codeword is performed better in initial transmission, through the definitions discussed herein and/or by measuring the paraters that indicate superior or more optimal performance, we can find the best rank 2 PMI results in corresponding permutation order to that particular codeword. Thus we generate the table in FIG. 4B.

FIG. 6 illustrates the example of a method of determining the PMI as described in a flowchart. Block 602 depicts causing a transmission initially, with an initial rank, on two codewords by a base station to at least one user equipment in a wireless network. Block 604 depicts receiving a negative acknowledgement such that at least one codeword was not decoded successfully. Block 606 depicts deciding to retransmit using a consequent rank for retransmission. Block 608 depicts selecting a precoding matrix indicator for the consequent rank retransmission. Block 610 depicts causing a retransmission, with the consequent rank, on the at least one codeword that was previously not decoded successfully.

FIG. 7 illustrates the example of a method of selecting the precoding matrix indicator for the consequent rank retransmission where block 702 represents determining a precoding matrix indicator from the initial rank transmission, block 704 represents identifying a precoder used by the codeword with better performance in the initial rank transmission, and block 706 represents selecting the precoding matrix indicator for the consequent rank retransmission.

The following are examples. In an example of an embodiment, (item 1) a method includes: causing a transmission initially, with an initial rank, on two codewords by a base station to at least one user equipment in a wireless network; receiving a negative acknowledgement such that at least one codeword was not decoded successfully; deciding to retransmit using a consequent rank for retransmission, wherein the consequent rank is lower than the initial rank; selecting a precoding matrix indicator for the consequent rank retransmission; and causing a retransmission, with the consequent rank, on the at least one codeword that was previously not decoded successfully.

Item 2. The method of item 1, wherein the initial transmission comprises a precoder for each of the two codewords.

Item 3. The method of item 1 wherein number of layers in the consequent rank transmission is less than number of layers in the initial rank transmission.

Item 4. The method of item 1, wherein the deciding is based on at least, one of the following: no new data on the codeword to be caused to be retransmitted; or a scheduler decides that the not successfully decoded codeword has a priority to be received.

Item 5. The method of item 2, wherein selecting the precoding matrix indicator for the consequent rank retransmission comprises: determining a precoding matrix indicator from the initial rank transmission; and identifying a precoder used by the codeword with better performance in the initial rank transmission.

Item 6. The method of any one of items 5, further comprising wherein the performance of each codeword is defined according to the modulation and coding scheme used in the initial transmission and positive acknowledgement or negative acknowledgement of each codeword.

Item 7. The method of item 6, wherein the identifying comprises: choosing the codeword with a higher modulation and coding scheme if different modulation and coding schemes are used; or choosing the codeword with the positive acknowledgement if same modulation and coding scheme is used.

Item 8. The method of item 5, wherein determining a precoding matrix indicator from the initial rank transmission comprises ascertaining the user equipment reported rank and precoding matrix indicator.

Embodiments of the present invention may be implemented in software (executed by one or more processors), hardware (e.g., an application specific integrated circuit), or a combination of software and hardware. In an example of an embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memory or other device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes examples of embodiments of the invention, these descriptions should not be viewed in a limiting sense. Rather, there are several variations and modifications which may be made without departing from the scope of the present invention as defined in the appended claims.

Without in any way limiting the scope, interpretation, or application of the claims appearing below, a technical effect of one or more of the examples of embodiments disclosed herein is to have improved performance for retransmission than if the rank used is the same as the initial transmission. Another technical effect of one or more of the examples of embodiments disclosed herein is improved system spectrum efficiency than if the embodiments described herein are not utilized.

The following abbreviations that may be found in the specification and/or the drawing figures are defined as follows:
2G second generation
3G third generation
3GPP third generation partnership project
ACK TCP to acknowledge the receipt
AS access stratum
BSC base station controller
BTS base transceiver station
CM connection management
CN core network
CQI channel quality indicator
CS circuit switched
CSI channel state information
DL downlink
DRMS demodulation reference signal
DTM dual transfer mode
eICIC enhanced inter cell interference coordination
EDGE enhanced data rates for GSM evolution
eNB or eNodeB evolved Node B (LTE base station)
EPDCCH enhanced physical downlink control channel
E-UTRAN evolved UTRAN
FER frame error rate
GERAN GSM EDGE radio access network
GGSN gateway GPRS support node
GMM GPRS mobility management
GMSC gateway MSC
GPRS general packet radio service
GSM global system for mobile communications
GW gateway
HLR home location register
HO handover
HSS home subscriber server
HTTP hypertext transfer protocol
IE information element
IMS IP multimedia subsystem
IP Internet protocol
L1 physical layer, also termed PHY
LTE long term evolution
LTE-A long term evolution-advanced
LTE-M LIE system to support MTC or M2M
Node B (NB) Node B (base station in UTRAN)
M2M machine-to-machine communications
MAC medium access control
MCS Modulation and Coding Scheme
MIMO multiple in, multiple out
MM mobility management
MME mobility management entity
MSC mobile switching center
MTC machine-type communications
NACK or NAK TCP to negatively acknowledge or reject a previously received message, or to indicate some kind of error
NAS non access stratum
NCE network control entity/element
NCT new carrier type
NZP non-zero power
PCRF policy control and charging rules function
PDCP packet data convergence protocol
PDN-GW packet data network-gateway
PDSCH physical downlink shared channel
PMI precoding matrix indicator
PRB physical resource block
PSTN public switched telephone network
PS packet switched
PUSCH physical uplink shared channel
RAB radio access bearer
RAN radio access network
RAT radio access technology
RAU routing area update
RB radio bearer
RE resource element
Rel release
RI rank Indicator
RLC radio link control
RNC radio network controller
RR radio resource
RRC radio resource control
RS reference signal
SGSN serving GPRS support node
SGW serving gateway
SINR signal to interference plus noise ratio
SMC security mode command
SNR signal-to-noise ratio
SRB signaling radio bearer
SRVCC single radio voice call continuity
TCP Transmission Control Protocol
TDM time-division multiplexing
TS technical specification
Tx or tx transmission or transmitter
TS technical standard
UE user equipment
UL uplink
ULA uniform linear array
UMTS universal mobile telecommunications system
UTRAN universal terrestrial radio access network
VoIP voice over IP 3GPP
ZP zero power

1. A method, comprising:
causing a transmission initially, with an initial rank, on two codewords by a base station to at least one user equipment in a wireless network;
receiving a negative acknowledgement such that at least one codeword was not decoded successfully;
deciding to retransmit using a consequent rank for retransmission, wherein the consequent rank is lower than the initial rank;
selecting a precoding matrix indicator for the consequent rank retransmission; and
causing a retransmission, with the consequent rank, on the at least one codeword that was previously not decoded successfully.

2. The method of claim 1, wherein the initial transmission comprises a precoder for each of the two codewords.

3. The method of claim 1, wherein number of layers in the consequent rank transmission is less than number of layers in the initial rank transmission.

4. The method of claim 1, wherein the deciding is based on at least one of the following:
no new data on the codeword to be caused to be retransmitted; or
a scheduler decides that the not successfully decoded codeword has a priority to be received.

5. The method of claim 1, wherein selecting the precoding matrix indicator for the consequent rank retransmission comprises:
determining a precoding matrix indicator from the initial rank transmission; and
identifying a precoder used by the codeword with better performance in the initial rank transmission.

6. The method of claim 5, wherein the performance of each codeword comprises:
the initial transmission modulation and coding scheme used; and
positive acknowledgement or negative acknowledgement of each codeword.

7. The method of claim 5, wherein the identifying comprises:
choosing the codeword with a higher modulation and coding scheme if different modulation and coding schemes are used; or
choosing the codeword with the positive acknowledgement if same modulation and coding scheme is used.

8. The method of any claim 5, wherein determining a precoding matrix indicator from the initial rank transmission comprises: ascertaining the user equipment reported rank and precoding matrix indicator.

9. An apparatus, comprising:
at least one processor and at least one memory including computer program code, wherein the at least one memory and the computer code are configured, with the at least one processor, to cause the apparatus to at least perform or control the following:
transmitting initially, with an initial rank, on two codewords by a base station to at least one user equipment in a wireless network;
receiving a negative acknowledgement such that at least one codeword was not decoded successfully;
deciding to retransmit using a consequent rank for retransmission, wherein the consequent rank is lower than the initial rank;
selecting a precoding matrix indicator for the consequent rank retransmission; and
retransmitting, with the consequent rank, on the at least one codeword that was previously not decoded successfully.

10. The apparatus of claim 9, wherein the initial transmission comprises a precoder for each of the two codewords.

11. The apparatus of claim 9, wherein number of layers in the consequent rank transmission is less than number of layers in the initial rank transmission.

12. The apparatus of claim 9, wherein the deciding is based on at least one of the following:
no new data on the codeword to be caused to be retransmitted; or
a scheduler decides that the not successfully decoded codeword has a priority to be received.

13. The apparatus of claim 9, wherein selecting the precoding matrix indicator for the consequent rank retransmission comprises:
determining a precoding matrix indicator from the initial rank transmission; and
identifying a precoder used by the codeword with better performance in the initial rank transmission.

14. The apparatus of claim 13, wherein the performance of each codeword comprises:
the initial transmission modulation and coding scheme used; and
positive acknowledgement or negative acknowledgement of each codeword.

15. The apparatus of claim 13 or 14, wherein the identifying comprises:
choosing the codeword with a higher modulation and coding scheme if different modulation and coding schemes are used; or
choosing the codeword with the positive acknowledgement if same modulation and coding scheme is used

16. The apparatus of claim 13, wherein determining a precoding matrix indicator from the initial rank transmission comprises: ascertaining the user equipment reported rank and precoding matrix indicator.

17. (canceled)

18. A communication system comprising the apparatus in accordance with claim 9.

19. (canceled)

20. (canceled)

21. A computer program product embodied on a non-transitory computer-readable medium, in which a computer program is stored which, when being executed by a computer, the computer program product is configured to provide instructions to at least control or carry out:
causing a transmission initially, with an initial rank, on two codewords by a base station to at least one user equipment in a wireless network;
receiving a negative acknowledgement such that at least one codeword was not decoded successfully;
deciding to retransmit using a consequent rank for retransmission, wherein the consequent rank is lower than the initial rank;
selecting a precoding matrix indicator for the consequent rank retransmission; and
causing a retransmission, with the consequent rank, on the at least one codeword that was previously not decoded successfully.
